(19) United States
(12) Patent Application Publication
(10) Pub. No.: US 2002/0186468 A1
(43) Pub. Date: Dec. 12, 2002

(54) Optical isolator

(76) Inventors: Chun Yu Lee, Tu-Chen (TW); Tai-Cheng Yu, Tu-Chen (TW); Ja Jn Dy, Tu-Chen (TW); Chien-Cheng Chen, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 09/956,311

(22) Filed: Sep. 18, 2001

(30) Foreign Application Priority Data
Jun. 8, 2001 (TW) 90209567

(51) Int. Cl. G02B 6/00; G02B 5/30; G02B 27/28

(52) U.S. Cl. 359/484; 385/11

(57) ABSTRACT

An optical isolator comprises a first collimator (10), an isolating unit (60), a second collimator (20) and an outer metallic holder (40). Each first and second collimator has a sleeve (12, 22), and the sleeve of the second collimator is longer than the sleeve of the first collimator. The isolating unit is stationed between the first and second collimators. The isolating unit comprises a first polarimeter (61), a polarized rotary crystal (62), a second polarimeter (63), and a magnetic ring (64). A length of the magnetic ring is slightly less than or equal to a combined length of the first and second polarimeters and the polarized rotary crystal. The magnetic ring is glued to an end surface of an inmost end of the sleeve of the second collimator. A subassembly of the first collimator, the isolating unit and the second collimator is received in the outer metallic holder.

### BACKGROUND OF THE INVENTION

1. Field of the Invention

The present invention relates to fiber optic optical isolators, and in particular to optical isolators having magnetic rings that are secured by gluing.

2. Description of Prior Art

In present-day optical fiber communications technology, semiconductor lasers are commonly used to generate and relay light signals to optical fibers. These lasers are particularly susceptible to reflected light signals that can cause the lasers to become unstable and noisy. Optical isolators are used to block reflected signals from reaching the laser. Optical isolators require low insertion loss for forward transmission of optical signals, and high attenuation for reverse transmission of reflected optical signals.

Referring to FIG. 1, a conventional optical isolator 1 comprises two collimators 10, an isolating unit 30 and an outer metal housing 40. Each collimator 10 is a standard collimator comprising a graded index (GRIN) lens 13 with 0.23 pitch, and a ferrule 14 for holding an optical fiber 15. The collimator 10 is used to convert light transmitted through the optical fiber 15 into parallel rays, to enhance coupling efficiency. The isolating unit 30 is stationed between the two collimators 10, and comprises a first polarimeter 31, a polarized rotary crystal 32, a second polarimeter 33 and a magnetic ring 34. Each polarimeter 31, 33 can polarize and separate light transmitted therethrough into an ordinary ray and an extraordinary ray, the two rays being orthogonal to each other. The polarized rotary crystal 32 adopts the Faraday effect of magneto optical crystals. That is, the polarized rotary crystal 32 is made of magneto optical crystals, and rotates polarized light passing therethrough 45° under the effect of a magnetic field. The rotation angle of the first polarimeter 31 is 45°. An optical axis of the second polarimeter 33 is oriented 45° with respect to an optical axis of the first polarimeter 31.

In a forward direction, light collimated by the first optical collimator 10 is passed through the first polarimeter 31 and separated into a first ordinary ray polarized along the optical axis of the first polarimeter 31, and a second extraordinary ray polarized perpendicularly to that optical axis. The ordinary ray and the extraordinary ray are then passed through the polarized rotary crystal 32 and rotated 45°. The rotated rays are recombined by the second polarimeter 33. The optical axis of the second polarimeter 33 is oriented 45° with respect to the optical axis of the first polarimeter 31. Thus the ordinary ray from the first polarimeter 31 is also the ordinary ray of the second polarimeter 33, and the extraordinary ray from the first polarimeter 31 is also the extraordinary ray of the second polarimeter 33. The result is that having traveled from the first polarimeter 31 through the second polarimeter 33, the two collimated rays are then negligibly displaced from each other. The two collimated rays are then combined and refocused by the GRIN lens 13 of the second fiber collimator 10 to an input end of the output optical fiber 15. Thus, light transmitted in the forward direction is passed through the optical isolator 1 with low loss.

In a reverse direction, however, light is separated by the second polarimeter 33 into an ordinary ray polarized along the optical axis of the second polarimeter 33, and an extraordinary ray polarized perpendicularly to that optical axis. When passing back through the polarized rotary crystal 32, both rays are respectively rotated 45°. This rotation is nonreciprocal with the rotation of light in the forward direction. The ordinary ray from the second polarimeter 33 is polarized perpendicularly to the optical axis of the first polarimeter 31, and the extraordinary ray from the second polarimeter 33 is polarized along the optical axis of the first polarimeter 31. The ordinary and extraordinary rays from the second polarimeter 33 have swapped places incident upon the first polarimeter 31. That is, the ordinary ray of the reflected light through the first polarimeter 31 is the extraordinary ray of the forward light therethrough, and the extraordinary ray of the reflected light through the first polarimeter 31 is the ordinary ray of the forward light therethrough. Because of this exchange, reflected light having passed through the first polarimeter 31 cannot leave the first polarimeter 31 in parallel rays. The non-parallel light is focused by the GRIN lens 13 of the first collimator 10 to points that are away from an output end of the input optical fiber 15. Thus, light transmitted in the reverse direction cannot reach the input optical fiber 15 to disturb the light source.

The collimator 10 of the optical isolator 1 is a standard collimator comprising a ferrule 14, a GRIN lens 13, a sleeve 12 and an inner metal housing 11. The ferrule 14 and the GRIN lens 13 are received and secured in the sleeve 12, and a part of the GRIN lens 13 projects from the sleeve 12. The inner metal housing 11 holds the sleeve 12. The first polarimeter 31, the polarized rotary crystal 32, and the second polarimeter 33 are respectively fixed in the magnetic ring 34. In assembly, an inmost end portion 131 of the GRIN lens 13 of the collimator 10 extending from the sleeve 12 is received in the magnetic ring 34. Thus, the collimator 10 and the isolating unit 30 are fixed together into a subassembly. The subassembly and another collimator 10 are then inserted into a tubular holder 111. The relative position between the subassembly and the another collimator 10 is adjusted to attain optimized insertion loss and isolation. The subassembly and the another collimator 10 are then fixed to the holder 111.

The isolator 1 has the following disadvantages. In order to securely connect the collimator 10 with the isolating unit 30 while ensuring precise positioning of these two parts, the magnetic ring 34 must be long enough to afford sufficient margins for adjustment. This makes the magnetic ring 34 unduly large and costly. In addition, the magnetic ring 34 and the GRIN lens 13 are connected by gluing. Excess glue sometimes causes contamination of the GRIN lens 13 or the first collimator 31. Such contamination results in high insertion loss of the isolator 1. Furthermore, the ferrules 14 of the collimators 10 are fixed in the sleeves 12. Thus it is more difficult to precisely adjust positions of the ferrules 14 relative to the GRIN lenses 13.

### SUMMARY OF THE INVENTION

In view of the above, it is an object of the present invention to provide a low-cost optical isolator with low insertion loss.

Another object of the present invention to provide an optical isolator that can be assembled without risk of excess glue contaminating parts of the isolator.

A further object of the present invention to provide an optical isolator that easily allows precise adjustment of ferrules thereof relative to graded index (GRIN) lenses thereof during assembly.

An optical isolator in accordance with a preferred embodiment of the present invention comprises a first collimator, an isolating unit, a second collimator and an outer metallic holder. Each first and second collimator has a sleeve, and the sleeve of the second collimator is longer than the sleeve of the first collimator. The isolating unit is stationed between the first and second collimators. The isolating unit comprises a first polarimeter, a polarized rotary crystal, a second polarimeter, and a magnetic ring. A length of the magnetic ring is slightly less than or equal to a combined length of the first and second polarimeters and the polarized rotary crystal. The magnetic ring is glued to an end surface of an inmost end of the sleeve of the second collimator. A subassembly of the first collimator, the isolating unit and the second collimator is received in the outer metallic holder.

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic cross-sectional view of a conventional optical isolator;

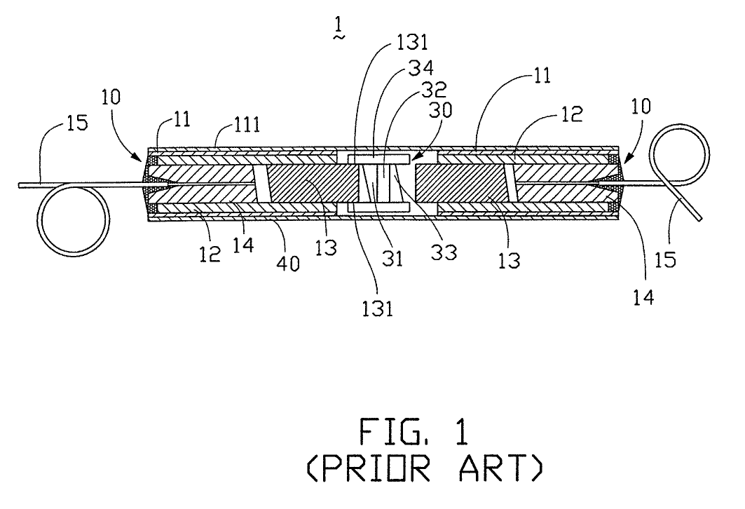

FIG. 2 is a schematic cross-sectional view of an optical isolator in accordance with a preferred embodiment of the present invention; and

FIG. 3 is a schematic cross-sectional view of an optical isolator in accordance with an alternative embodiment of the present invention.

### DETAILED DESCRIPTION OF PREFERRED EMBODIMENTS OF THE INVENTION

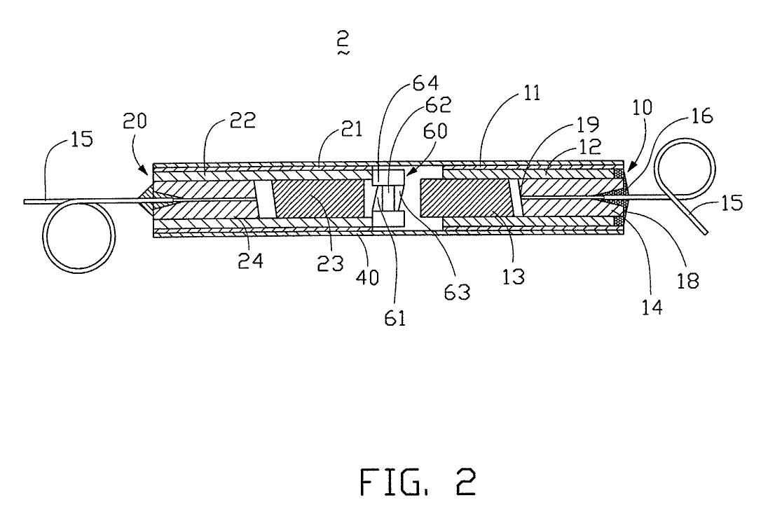

Referring to FIG. 2, an optical isolator 2 in accordance with a preferred embodiment of the present invention comprises a first collimator 10, a second collimator 20, an isolating unit 60 and an outer metallic holder 40.

The first collimator 10 comprises a first ferrule 14, a first graded index (GRIN) lens 13, a first sleeve 12 and a first inner metallic housing 11. The first ferrule 14 comprises an outer first end 18, an inner second end 19, and an axial hole 16. An annular chamfer is formed around the hole 16 at the first end 18, to allow easy insertion of an optical fiber 15 into the hole 16. An inmost surface of the second end 19 is ground to a predetermined angle relative to a longitudinal axis of the first ferrule 14, and is coplanar with an inmost surface of an input end of the optical fiber 15. In the preferred embodiment, the first sleeve 12 is made of glass, and secures the first GRIN lens 13 and the first ferrule 14 therein. An inmost end of the first GRIN lens 13 projects from the first sleeve 12. A length of the first inner housing 11 is approximately equal to a length of the first sleeve 12, for fully securing the first sleeve 12 therein and thereby protecting components within the first sleeve 12.

The second collimator 20 comprises a second ferrule 24, a second GRIN lens 23, a second sleeve 22 and a second inner metallic housing 21. The second collimator 20 is a mirror image of the first collimator 10, except that the second sleeve 22 of the second collimator 20 is longer than the first sleeve 12 of the first collimator 10. Thus the second GRIN lens 23 is fully secured within the second sleeve 22, and does not project from the second sleeve 22. Another optical fiber 15 is inserted into the second ferrule 24.

The isolating unit 60 is stationed between the first and the second collimators 10, 20. The isolating unit 60 comprises a first polarimeter 61, a polarized rotary crystal 62, a second polarimeter 63, and a magnetic ring 64. The first polarimeter 61, the polarized rotary crystal 62 and the second polarimeter 63 are respectively fixed within the magnetic ring 64. The first polarimeter 61 and the second polarimeter 63 are birefringent crystals, and an optical axis of the first polarimeter 61 is oriented 45° with respect to an optical axis of the second polarimeter 63. The polarized rotary crystal 62 is a Faraday rotator, and rotates polarized light passing therethrough 45°. A length of the magnetic ring 64 is slightly less than or equal to a combined length of the first and second polarimeters 61, 63 and the polarized rotary crystal 62.

In assembly, the magnetic ring 64 with the first polarimeter 61, the polarized rotary crystal 62 and the second polarimeter 63 secured therein is fixed to an inmost end of the second sleeve 22 of the second fiber collimator 2. An annular end surface of the magnetic ring 64 facing the second sleeve 22 is glued to an annular end surface of the inmost end of the sleeve 22, thereby forming a subassembly. The subassembly and the first collimator 1 are then placed within the outer metallic holder 40.

A position of the second ferrule 24 and a relative position between the first collimator 10 and the second collimator 20 are adjusted, to optimize insertion loss and isolation of the isolator 2. The second ferrule 24 is then fixed to the second sleeve 22. The first and second collimators 10, 20 are fixed within opposite ends of the outer metallic holder 40 respectively. Assembly of the isolator 2 is thereby completed.

An axial length of the magnetic ring 64 is less than that of conventional isolators, making the isolator 2 more cost-effective. Furthermore, the magnetic ring 64 is adhered to the inmost end of the second sleeve 22 of the second collimator 20, rather than directly to the second GRIN lens 23. Thus the risk of excess glue contaminating the second GRIN lens 23 or the first polarimeter 61 is eliminated.

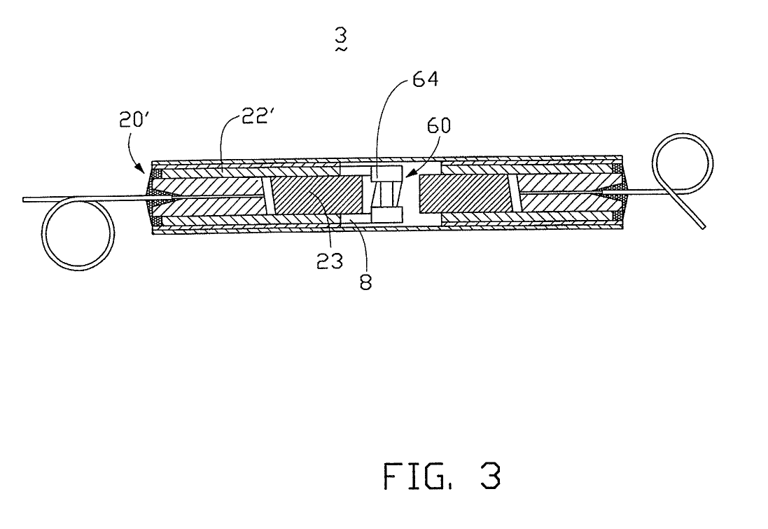

FIG. 3 shows an optical isolator 3 in accordance with an alternative embodiment of the present invention. The isolator 3 is substantially the same as the isolator 2, except for the following differences. The isolator 3 has a second collimator 20′, a second sleeve 22′, and a glass ring 8. A length of the second sleeve 22′ is less than a length of the second sleeve 22 of the isolator 2. Thus a second GRIN lens 23 has an inmost end projecting from the second sleeve 22′. Outer and inner diameters of the ring 8 are the same as outer and inner diameters of the second sleeve 22′. The ring 8 is glued to an annular inmost end surface of the second sleeve 22′. The inmost end of the second GRIN lens 23 is thereby completely accommodated within the ring 8. A magnetic ring 64 of an isolating unit 60 is glued to an annular inmost end surface of the ring 8.

It should be understood that various changes and modifications to the presently preferred embodiments described herein will be apparent to those skilled in the art. These changes and modifications may be made without departing from the spirit and scope of the present invention and without diminishing its attendant advantages. Thus, it is intended that such changes and modifications be covered by the appended claims and their equivalents.

1. An optical isolator comprising:
a first collimator including a first ferrule, a first lens and a first sleeve which receives and fixes the first ferrule and the first lens therein;
a second collimator including a second ferrule, a second lens and a second sleeve which receives and retains the second ferrule and the second lens therein, the second sleeve accommodating the entire second lens therein; and
an isolating unit located between the first and the second collimators, the isolating unit including a first polarimeter, a polarized rotary crystal, a second polarimeter and a magnetic ring, the first polarimeter, the polarized rotary crystal and the second polarimeter being respectively fixed in the magnetic ring, the magnetic ring being glued to an inmost end of the second sleeve.

2. The optical isolator as described in claim 1, wherein an inmost end of the lens of the first collimator projects from the first sleeve.

3. The optical isolator as described in claim 1, wherein each first and second collimator further includes an inner metallic housing receiving a corresponding sleeve therein, and each inner metallic housing has a length substantially equal to a length of the corresponding sleeve.

4. The optical isolator as described in claim 1, wherein each first and second sleeve is made of glass.

5. The optical isolator as described in claim 1, wherein each first and second lens is a graded index lens.

6. The optical isolator as described in claim 1, wherein the first and second polarimeters are birefringent crystals, and the polarized rotary crystal is a Faraday rotator.

7. The optical isolator as described in claim 1, wherein a length of the magnetic ring is slightly less than or equal to a combined length of the first and second polarimeters and the polarized rotary crystal.

8. An optical isolator comprising:
an outer metallic holder;
first and second collimators received in the holder and respectively fixed in opposite ends of the holder; and
an isolating unit received in the holder between the first and second collimators; wherein
the first and second collimators each comprise a glass sleeve, a ferrule received in the sleeve, an optical fiber extending into the ferrule, and a graded index lens received in the sleeve, the graded index lenses being located between the ferrules, the sleeve of the second collimator being longer than the sleeve of the first collimator so that the graded index lens of the second collimator is entirely received in the sleeve of the second collimator, the isolating unit having a magnetic ring glued to an inmost end of the sleeve of the second collimator.

9. The optical isolator as described in claim 8, wherein the sleeve of the second collimator is formed as a single piece.

10. The optical isolator as described in claim 8, wherein the sleeve of the second collimator is formed as first and second pieces, the first piece receiving a part of the graded index lens of the second collimator therein, with another part of the graded index lens of the second collimator projecting from the first piece, the second piece receiving the said another part of the graded index lens of the second collimator therein, and wherein the magnetic ring of the isolating unit is fixed to an inmost end of the second piece.

11. The optical isolator as described in claim 8, wherein each of the first and second collimators further comprises an inner metallic housing receiving a corresponding sleeve therein, each inner metallic housing being received in the outer metallic holder.

12. An optical isolator comprising:
a first collimator including a first ferrule and a first lens commonly retainably enclosed within a first sleeve;
a second collimator including a second ferrule, a second lens and a second sleeve enclosing at least a portion of said second lens;
a metallic holder enclosing both said first collimator and said second collimator therein; and
an isolating unit located between said first and second collimators, the isolating unit including a first polarimeter, a polarized rotary crystal and a second polarimeter all commonly retainably enclosed with a magnetic ring; wherein
an inmost end of said first sleeve is located behind a distal end of the first lens while an inmost end of said second sleeve is located ahead of a distal end of the second lens, and the magnetic ring is fixed to said inmost end of the second sleeve along an axial direction of said metallic holder instead of fixing to the second lens in a radial direction thereof.
